(19) United States
(12) Patent Application Publication
(10) Pub. No.: US 2015/0161561 A1
(43) Pub. Date: Jun. 11, 2015

(54) Method and System to Determine, Suggest, Project, and Dictate Mail Recipients and Sending Methods In The Sending of Construction Notices and Other Documents

(71) Applicant: Scott Gerard Wolfe, JR., New Orleans, LA (US)

(72) Inventor: Scott Gerard Wolfe, JR., New Orleans, LA (US)

(21) Appl. No.: 14/103,168

(22) Filed: Dec. 11, 2013

(51) Int. Cl. G06Q 10/08; G06Q 50/18; G06Q 10/10

(52) U.S. Cl. CPC G06Q 10/0832; G06Q 10/107; G06Q 50/18

(57) ABSTRACT

System to determine, based on certain data elements, such as a construction project's location and type or a system user's role and contracting tier, who must receive a particular legal notice or document, and how that document must be sent to said parties. After the determination has been made, implementation of the system to offer and make such suggestions through a computer, device, or user interface, and through an ordering system. In addition to making such suggestions, a process that dictates the required recipients and sending methods such that a system can automatically deliver the document to the applicable parties via the applicable methods.

### CROSS REFERENCE TO RELATED APPLICATIONS

This Nonprovisional Utility patent application claims the benefit of a previously filed provisional patent under 35 USC 199(e), the application number of which is 61/735,723.

### BACKGROUND OF THE INVENTION

The present invention relates to the field of mechanics lien and bond claim compliance, and is specifically related to the delivery of legal notices required to preserve, comply with, perfect, or enhance a party's mechanics lien and/or bond claim rights.

These legal notices are generally required according to statutory rules, with the requirements for whether a legal notice is or is not mandatory heavily dependent on a variety of circumstances. When a legal notice is required, the legal notice must be delivered in a certain manner, which again, may depend heavily on a variety of circumstances.

In addition to these specific legal notices, which are used an example implementation of this invention, the present invention may also be applicable to other types of documents delivered by physical delivery, including, but not limited to, other required legal notices, demand letters, form letters, and other documents.

This invention, through a computer or computer program, leverages a systemized process of organizing and determining delivery method requirements, and applies said process to user generated data to determine, suggest, project, and/or dictate the system's or system user's handling of a legal notice or document.

### SUMMARY OF THE ART

### Mechanics Liens and Notices

Those furnishing labor, materials and/or services to private, state and federal construction projects around the United States have possible “mechanic's lien” claims in the event they are unpaid for their contribution. Popularly referred to as a “mechanic's lien,” the legal remedy is also called a “claim of lien,” “materialmen's lien,” “property lien,” “contractor lien,” “construction lien,” “statement of claim and privilege,” “notice of claim of lien,” and “stop work order.” When the labor, materials or services are furnished to a construction project owned privately (non-governmental ownership), the lien is placed against the property itself. When the labor, materials or services are furnished to a state or federal construction project, a lien against the government owned property is typically not available, but instead a “lien” is made against a bond under the federal Miller Act or each individual state's “Little Miller Act.” This lien remedy, which goes by many names and has different characteristics depending on the construction project's type, is referred to herein collectively as a “mechanic's lien.”

While the ability to file a mechanic's lien is uniformly available across the United States and its territories, the laws regulating its filing differs from state-to-state. In addition to each state having unique mechanic's lien laws, within these laws different treatment is afforded to construction participants depending on their role in the project (i.e. original contractor, subcontractor, architect, supplier, equipment lessor, etc), their tier in the project (i.e. their place in the contractual chain starting from the property owner or public entity commissioning work) and the type of construction project where services are furnished (i.e. commercial, residential, owner-occupied residential, industrial, oil & gas, state, federal, etc.).

To preserve one's right to file a mechanics lien, many states require project participants to meet pre-lien statutory notice requirements. In some states, notices are required before services are provided, and in others notices are required within a certain period before the lien is filed. In other states, notices are not required at all. These notices must meet statutory requirements, and must be sent according to the state's statutory service or delivery standards. These construction notices, including, but are not limited to, notices of the following names and types: preliminary notices, pre-lien notices, notices to owner, notices of commencement, notices of intent to lien, notices of furnishing labor/materials, notices of lease, model disclosures, notices of completion or cessation, notices of lease, etc. Similar to a mechanic's lien, each state has specific requirements for how and when notices must be filed, served, or sent, to whom notices must be filed, served, or sent, and what must be included on the notice. These notices differ from mechanic's liens in that notices are only preliminary documents necessary to retain the right to claim a mechanic's lien at a later date, or optionally sent to notify or warn a recipient about the right to claim a mechanic's lien at a later date. The notices, collectively herein referred to as “preliminary notices” or “construction notices,” where and when required, may be necessary to a claim a mechanic's lien, but are not sufficient, by themselves, for a mechanic's lien.

Each notice has specific and varied legal requirements, regarding who is to be given notice, how they must be given notice, and when the notice must be given. In some states, the notices are required to be given on a recurring basis for every month in which the potential lien claimants is unpaid for their work. The legal requirements for construction notices also vary by the role of the party giving notice (i.e. general contractor, subcontractor, material supplier, equipment lessor, etc.), as well as by the state in which the project was located, and the project type (i.e. commercial, residential, public, etc.).

The act of filing a mechanics lien is also subject to varied legal requirements, with each state setting forth specific elements required within a mechanic's lien. After a lien is filed, many states require the mechanic's lien be served upon certain parties through pre-defined methods.

Finally, the mechanic's lien is a temporary encumbrance on private property or a surety bond. The encumbrance lasts for a specific period of time as provided by each jurisdiction's statute, and the encumbrance expires at the end of this time period unless action is taken by the lien claimant. In some jurisdictions, the mechanic's lien claim may be “extended” through a supplemental filing. When unable to extend or further extend a lien, the mechanic's lien claim must be “foreclosed upon” by filing an action seeking foreclosure in a designated court of law.

### Construction Projects and Participants

The construction industry is one of the largest industries in the United States, and includes a variety of parties who engage in the construction or alteration of any improvement projects.

Improvement projects may be of a variety of “types,” which include residential projects, commercial projects, industrial projects, state owned projects or works, federally owned projects works, and more. Throughout this application, this will be referred to as a “project type.”

A variety of parties participate in the construction or alteration of said improvement projects. Parties are identified by the roles they play on an improvement project, and may be classified as a developer or owner, a general contractor, construction manager, architect, engineer, subcontractor, trade contractor, supplier, sub-subcontractor, sub-sub-subcontractor, sub-sub-sub-subcontractor, equipment rental company or equipment lessor, lender, mortgagor, lien agent, or more. Throughout this application, this will be referred to as a “role.”

Throughout this application, the project as a whole will be referred to as a “project” or “construction project.”

### Other Legal Notices, Form Letters, or Demand Letters:

Construction notices or preliminary notices is one type of statutorily required legal notice, however, there are a variety of legal notices that must be sent according to statutory requirements that depend on a variety of circumstances. Examples of legal notices include: Notices to vacate tenants, bank foreclosure notices, open account letters, collection demand letters, fair credit reporting act letters and notices, contractually required notices, service of process notices within legal proceedings or alternative dispute resolution proceedings, notices that must be sent by governing bodies to warn of government action, and more.

In all cases, statutory rules or case law dictates who must receive these notices, and how these notices must be delivered.

### Web Applications, Product Ordering Interfaces, Mobile Applications, Widgets, Communications Networks:

The World Wide Web (WWW) is a well-known network of computers, whereby users around the world can access information displayed within a web browser. Typically the user accesses certain web pages that are displayed to the user through the HTML (Hyper-Text Markup Language) protocol. The user calls and retrieves specific HTML pages by requesting the page through a known URL (Uniform Resource Locator) using HTTP (HyperText Transfer Protocol).

Using certain computer languages such as PHP, Javascript, and HTML, listed here illustratively only and as examples, it has become common for companies and individuals to write applications that run and operate through web browsers on the World Wide Web. These web applications are similar to software applications that are written to operate on a user's desktop, except that they run through web browsers on the web.

Typically, a user will visit a certain website and be required to login to their account. Once logged in, the user will have access to the web application and its features. A web application can be designed to appear on a web browser access via a personal computer, or on a “mobile browser,” which is a web browser optimized for viewing on a mobile device.

Although web applications viewing on a standard web browser may be viewed on a mobile device through a mobile web browser, mobile devices also have the ability to run native mobile applications. These applications are optimized to operate on a mobile device (such as an iPhone or iPad, or an Android OS device) with or without the use of an Internet connection. The user opens the application on his or her mobile device and is able to view, alter and interact with the application without the use of a browser.

Next, a Product Ordering Interface is an interface on the WWW that a user accesses through an HTTP request. Here, the user will find the ability to order certain products from the website, including, in the instance of this invention, mechanic's liens, bond claim forms, preliminary notices, lien cancellations, and similar products.

A popular Product Ordering Interface is the “shopping cart” model, whereby a purchaser selects an item from an electronic catalog, which is electronically added to the purchaser's “shopping cart”, and when the purchaser is done selecting items all the orders in the shopping cart are “checked out” when the purchaser provides its billing and/or payment information.

Another Product Ordering Interface that is also popular is the less-sophisticated form-based system, whereby the purchaser selects the product or service through an electronic catalog of services or products, and is then forwarded to an online form where information about the purchaser (including, perhaps, the billing and payment information) is gathered.

Finally, a “widget” is a term of art defined by Wikipedia as “a small application that can be installed and executed within a web page by an end user.” Or more further described therein as “a stand-alone application that can be embedded into third party sites by any user on a page where they have rights of authorship.” Other terms used to describe web widgets include: portlet, gadget, badge, module, webjit, capsule, snippet, mini and flake.

A widget may be installed on any web page, displaying content to the viewer, or offering a certain application or function to the viewer. When an application or function is offered, the widget runs a script stored on the originating server, such that the viewer is able to complete a function within the widget without the host-site storing the function's code and framework.

For the purposes of this Specification, all of these applications, interfaces and networks, together with other non-discussed offline software systems and electronic communications, are collectively referred to as the “System” or “Application.”

### Summary of the Art: Construction Lien and Notices Services

Law firms, attorneys, form companies, software companies, legal document preparation companies, and similar service and product providers offer services or products to contractors, owners, suppliers, architects, engineers and other construction participants that aid them with filing construction lien and notices, and/or managing lien and bond claim compliance. Construction liens and notices are form-driven documents, meaning that when filed or delivered, they are simply forms filled-in with the applicable information. The form varies from state-to-state, and also varies depending on other factors related to a subject construction project, including, but not limited to, the “type” of project, the role that the party is engaged on the project, and their tier in the construction contracting chain.

The differences in the forms applicable to a party's particular circumstance depend on a large number of variables, which when spread across the country, creates a significant variety of form-types that can be used for all the different construction liens and notices that may be filed.

Many companies sell forms online or in paper format at retail locations, or over the Internet. The customer's experience is that the user searches for the type of form they need (without a significant degree of help or instruction), buy the form, and fill it in with the applicable information. The forms are static, and offered as packaged only.

Other companies, commonly known as legal document preparation companies or document automation companies, will collect information from the customer, and then fill-in the form for them. In the construction industry, and particularly with regard to construction liens and notices, it is also common for these companies to deliver or file the form after completion as part of the service. Some providers will fill in the information on the form manually for a customer, and others will use some type of software product or document automation tool to generate the document.

Attorneys and law firms offer legal advice and the preparation of legal documents, which may include the preparation of legal forms.

Finally, some companies sell software that will generate forms for the customer using document automation technology.

These services and service providers are distinguished from this Invention in that, while these service providers may have use for this Invention, they do not have a method and system, using a computer or computer program, for leveraging a systemized process of organizing and determining requirements in the method of delivering construction notices and the recipients of said notices, and applying said process to user generated data to determine, suggest, project, and/or dictate the system's or system user's handling of a legal notice.

### Summary of the Art: Physical Mail and Physical Delivery Management

Physical parcels of mail are delivered by a variety of vendors including the United States Postal Service (USPS), UPS, FederalExpress, DHL, and more. In regards to legal notices, such as construction notices, the method of delivery is restricted by the state's statutes. While some situations allow delivery through any third party courier service, the vast majority of jurisdictions require legal notices be delivered through the USPS.

Even further, when the USPS delivery is required, a state's law will typically mandate that the legal notice be delivered in some specific way through the USPS. In this regard, the USPS offers a variety of mailing services, including “certified mail,” “registered mail,” “certified mail return receipt,” “registered mail with restricted delivery,” etc. The services offered by the USPS vary from time-to-time.

In some cases, mailing labels or mailing envelopes can be generated from a delivery vendor (i.e. USPS, UPS) using tools made available by these vendors. These tools may be integrations with the vendor's application programming interface (“API”), or through some software offering.

Further, some vendors are available to perform mailing functions. The experience of working with these vendors is to deliver physical documents or electronic documents to the third party vendor with instructions on how to deliver the documents. The vendor will deliver the provided documents according to the delivery instructions.

Sorting these documents and managing the process of delivering the documents to the parties according to provided requests and instructions is the subject of many processes, including, for example, the process described in Patent Application WO 2011066562 AI, “System and method for creating an intelligent mail barcode.” This invention is easily distinguished from these types of processes because it does not claim any processes related to the actual sorting, printing, packaging, mailing, delivery, and/or tracking of mail pieces.

The state of the art is not crowded currently in methods and systems of determining who the mail recipients should be. One patent application that does do this is US 20130035982 A1, which is a “Method and system for creating targeted advertising utilizing social media activity.” This invention is easily distinguishable from this application since the mail recipient determination described in this application relies upon system generated and/or stored rules and user generated data within the system.

The state of the art is also not crowded with respect to methods and systems of determining how particular mail pieces ought to be delivered pursuant to some delivery requirement.

### BRIEF SUMMARY OF THE INVENTION

This invention, through a computer or computer program, is a system, method, and process of organizing and determining delivery method requirements for certain documents and scenarios, and organizing and determining delivery recipients required for certain documents and scenarios, and thereafter, according further to the computerized system, method, and process, applies the foregoing organized rules to determine, suggest, project, and/or dictate the system's or system user's handling of a legal notice or document.

An example discussed herein of how this invention is applied relates to the delivery of construction notices. Using the system and method described herein, the invention takes limited, specific information about a construction project, including the project's type and the role of the parties delivering the construction notice, to determine who must receive the construction notice and how that notice must be delivered to the recipients.

After said determination is made, this invention contemplates a computer system, through a user, computer, or device interface, or a Product Ordering Interface, displaying or suggesting the determined requirements to the system user.

In addition to determining and suggesting the requirements, or in lieu thereof, this invention contemplates a system and method of projecting the requirements and dictating the requirements, such that a system can automatically prepare the document—in this case, the construction notice—for delivery to the applicable parties through the applicable method.

### BRIEF DESCRIPTION OF DRAWINGS

FIG. 1 shows example table structure for database records related to the delivery methods and contact labels, which are referred to and/or relied upon by the method and system contemplated in this invention. In the FIG. 1.1, the “Delivery Method Database Records,” the system administrator is able to create specific records for various delivery methods. As evidenced in 1.1, the delivery method is given a unique identifier. As part of the delivery method database record, a “Delivery Method Vendor” is required, and this example database table structure contemplates a separate table to organize delivery vendors (FIG. 1.2), which are also given unique identifiers, with said identifier being associated with every delivery method record. 1.3 provides an example table structure for contact records or contact labels. System users are able to affiliate contact records (i.e. records identifying parties, organizations, companies, etc.) with a “label,” and therefore, the system, through a database or other data source, has a table structure where these labels are stored and managed.

FIG. 2 is an example demonstration of an administrator screen, within a computer system, whereby document records (which are records, references, or scripts identifying the construction notice or document that must be mailed) are associated with a delivery method. In this FIG. 2 example, the document record is associated with the delivery method “by certified mail return receipt.”

FIG. 3 is an example administrator screen whereby an administrator, within a computer system, can search for and view document records within the database or computer program. The screen in this example, on the far right hand side of the screen under the pencil icon, indicates whether any “recipient records” are associated with the document record, and if so, how many records.

FIG. 4 is an example administrator screen whereby an administrator, within a computer system, can view the “recipient records” associated with a particular document record. In this example, the administrator is viewing the “California, Preliminary Notice” document record, and therein, there are 4 recipient records listed.

FIG. 5 is an example administrator screen, within a computer system, for a “recipient record,” which establishes and organizes within the system which contacts are mandatory recipients for the designated document. In this example, which relates to a construction notice, selected in the the administrative area are on the left side the “General Contractor” as the “Hired-By Roles” and the “Property Owner/Public Entity,” “General Contractor” and “Lender” as the “Recipient Roles.” As further explained in this invention's description, the result of this “recipient record” is to create a rule within the system that whenever the document record associated with this recipient record is created, the mandatory recipients are those identified in the “Recipient Roles” whenever the system user's “Hired-By Role” is the role(s) identified.

FIG. 6 is a more detailed graphical representation of the example process, system, and method discussed in FIGS. 2-5, supra.

FIG. 7 is an example computer, device, or user interface, whereby the calculated delivery method and delivery recipient requirements are displayed to a system user or administrative user for a particular document.

FIG. 8 is an example Product Ordering Interface, through a computer program or computer, whereby suggestions about delivery method and delivery recipients is suggested to a system user during the process of ordering a particular document.

FIG. 9 is an example administrative area, consisting of a user, device, administrative, or computer interface, as part of a computer program or display through a computer, whereby suggestions about delivery method and delivery recipients is suggested to a system user or administrative user, during a process of printing the document, sending the document to a batch for mail or delivery processing, or otherwise processing the document for delivery.

FIG. 10.1 provides an overview of the invention's system and method by examining the organization and storage of general system data within the computer system or database. According to 10.1, the computer system or computer database contains a universe of information, including a universe of documents (and their identifiers), a universe of delivery methods (and their identifiers), and a universe of “party labels,” or tags, to label contact records (and their identifiers).

FIG. 10.2 provides an overview of the invention's system and method by examining the organization and storage of affiliations between the general system data identified within FIG. 10.1. Specifically, as demonstrated in 10.2, document identifiers are affiliated with delivery method identifiers, such that certain delivery methods are associated with certain documents (A). Similarly, certain required recipient records, connects party label identifiers with document record identifiers (B).

FIG. 10.3 provides an overview of the invention's system and method by examining the organization and storage of system user data. While the general system data examined in FIGS. 10.1 and 10.2 relates to data stored (generally statically) within the computer system or computer database, FIG. 10.3 relates to data that is inputted and managed by a system user (generally dynamic). As demonstrated in FIG. 10.3, the system user creates Project Records, and affiliates contacts/party label identifiers with the project record, inputs data that creates a relationship between the system user and the various contact records, and eventually, for the purposes of this invention, associates document records when such documents are ordered, requested, generated, or otherwise attained, with the project records.

FIG. 11 is an example process whereby a record created by the process of this invention is transmitted to a third party vendor for packaging and mailing according to the instructions determined by the invention's process.

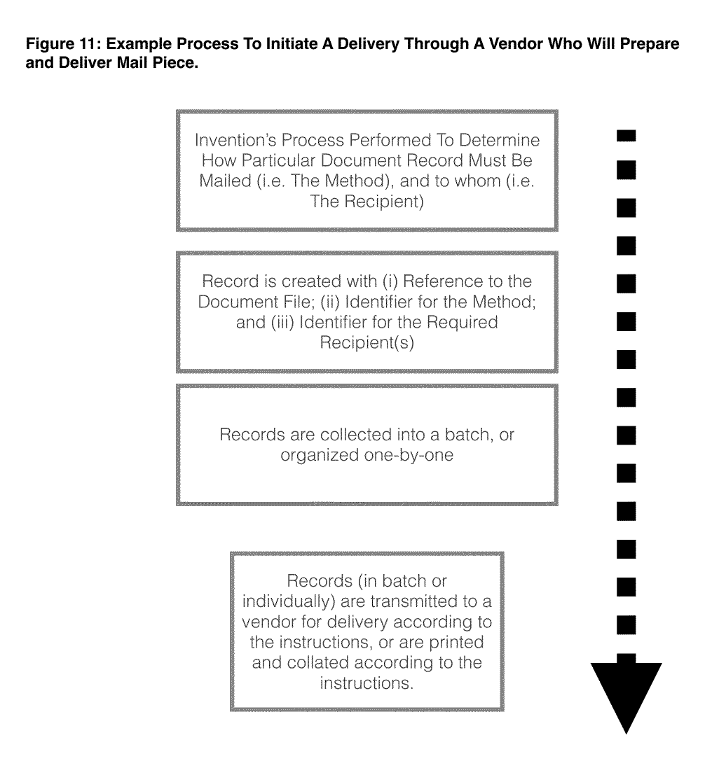

FIG. 12 is an alternative example application of the invention with detailed graphical representation of the example process, system, and method of this invention. Unlike the graphical representation in FIG. 6, which relates to the example of construction notices, this Figure relates to the example of other legal notices. According to the invention (as seen from FIG. 6 and this FIG. 12), the system and method of determining the delivery method and delivery recipients requires an examination of delivery methods affiliated with document records and/or item records, and an examination of the recipient records affiliated with a document record. In the case of FIG. 6 and the construction notices, the delivery method is associated with the document record only, and the recipient records are associated with both recipients (who should get the document) and role/contact role data about the system user (which determines which recipient record will apply). FIG. 12, on the other hand, relates to legal notices, whereupon the delivery method is again associated with a document record and/or item record, and the recipient record is associated with the document record; however, in the case of FIG. 12, the user's role or contact label is not applicable, as only the recipients contact label is used.

### DETAILED DESCRIPTION OF THE INVENTION

### A. System and Method of Organizing Rules about how Documents Must be Delivered, and to Whom, and Thereafter, a System and Method for Calculating and Determining how Certain Documents Must be Delivered, and to Whom, in Specific Relation to System User Data

This invention's method performs a process through a computer system to determine how certain documents—i.e. construction notices, other legal notices, or other documents—must be delivered, and to whom the documents must be delivered.

The structure for this method relies upon some organization in a computer database, program, or other data source, whereby “delivery methods” and “contacts” are defined.

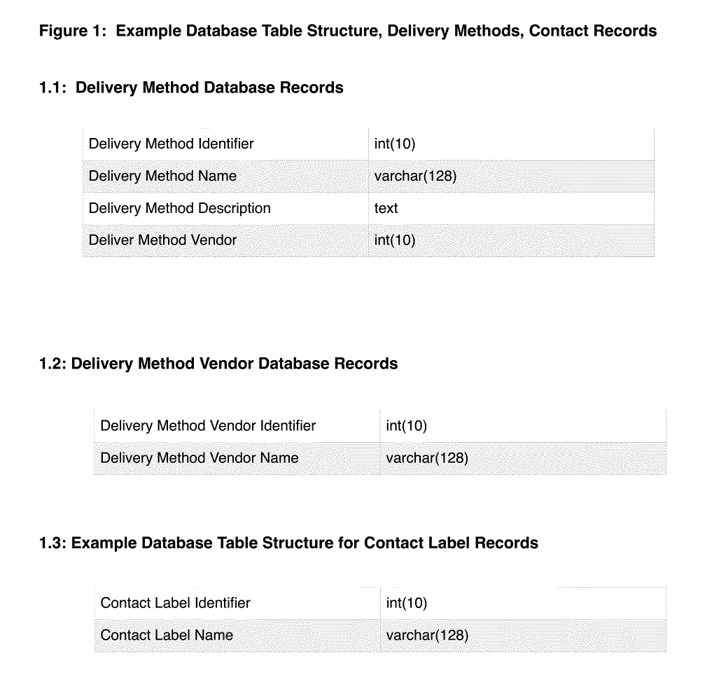

As to “delivery methods,” this invention sets forth a system and method of dictating how certain documents must be delivered. This is referred to herein as the “delivery method,” and accordingly, there is some universe of potential delivery methods stored within the computer database or otherwise programmed and managed in a computer system or program. FIGS. 1.1 and 1.2 provide an example database table structure to manage, organize, and store delivery methods within a computer system. Specifically, 1.2 establishes a list of delivery method vendors, such as, for example, the United States Postal Service and Federal Express. FIG. 1.1 establishes a list of delivery methods, which are affiliated with vendors, such as Certified Mail (performed by USPS), or Overnight Standard (performed by FedEx).

As to “contacts,” identifying information about people, organizations, companies, governmental entities, and other parties are stored in the computer program, database, or data source as a “contact” or “contact record.” This identifying information includes, but is not limited to, the name of the party and the party's address. This includes, but is not limited to, identifying information about the system user themselves. It is very common for computer systems to store data about parties as a “contact record.” It is also common for computer systems and programs to enable a system user to “tag” or “label” a certain contact.

FIG. 1.3 provides an example database table structure for organizing, managing, and/or storing labels or tags about contact records. A contact label is provided a name and an identifier in the database, and any contact record therein may be affiliated with the label identifier.

Utilizing the universe of potential “delivery methods” and “contact labels,” stored within a computer program, system, database, or data source, pursuant to the example above or otherwise, this invention's method performs a process whereby the “delivery method” for a specific document is determined from the universe of methods stored for the system, and the recipients of the specific document is determined from the universe of “contact records” stored for the user.

The components of this part of the invention are:

(1) The method, through a computer or computer program, of determining and displaying the delivery method for a document; and
(2) The method, through a computer or computer program, of determining and displaying the recipients who are required to receive a document, based upon the rules established and stored within the system.

This invention does not claim the underlying process and/or method of labeling contact records, storing contact records, storing contact labels, labeling delivery methods, and/or storing delivery methods.

Instead, this invention claims and relates to the connecting and associating of “delivery methods” with document records and/or a user's specific item record, such as a project record or an account record. Further, this invention claims and relates to the connecting and associating of certain “contact labels” with specific documents records and/or data scenarios, such that, depending on the document at issue and the data scenario of a user's item record, certain specific contact records can be established as required recipients for a document based upon the same.

This invention leverages affiliations and relationships between system data and user generated data.

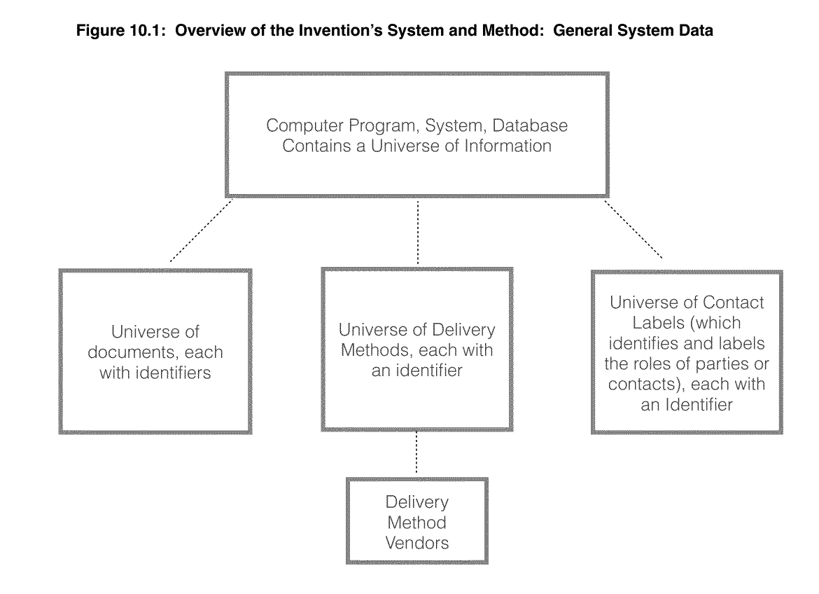

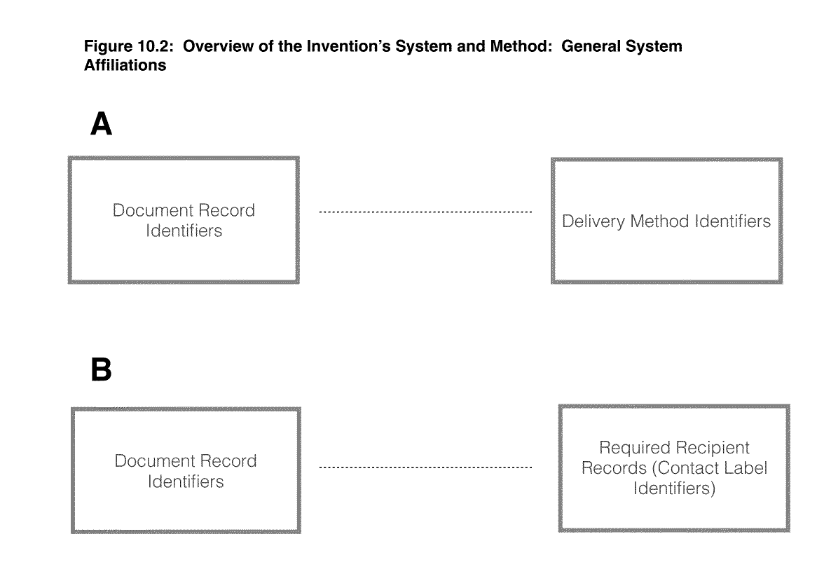

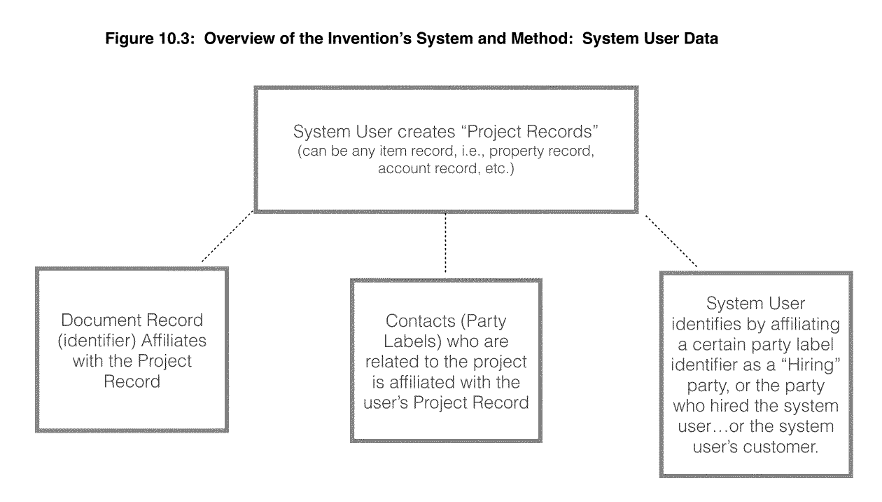

First, with regard to system data, the computer program, system, database, or other data source contains a universe of certain information. This is demonstrated in FIG. 10.1, which is an “Overview of the Invention's System and Method: General System Data.”

As demonstrated therein, the computer program, system, database, or other data source contains a “universe of documents, each with identifiers.” These documents are records of the actual document that requires delivery, such as a construction notice or other legal notice. The document record may be a reference to a static file, or a form housed in a document assembly software product, or just an indication of the document name for information purposes. Regardless, the document record itself has an identifier and a universe of potential documents is organized and stored in the system.

Further demonstrated, the computer program, system, database, or other data source contains a “universe of delivery methods, each with an identifier,” and “universe of contact labels . . . each with an identifier.” These “delivery methods” and “contact labels” are discussed supra in the discussion of FIGS. 1.1, 1.2, and 1.3.

Second, the “universe of data” within the computer program, system, database, or other data source are connected and affiliated with one another, such that, as per the example in FIG. 10.2, document records are affiliated with (i) delivery methods identifiers; and (ii) contact label identifiers.

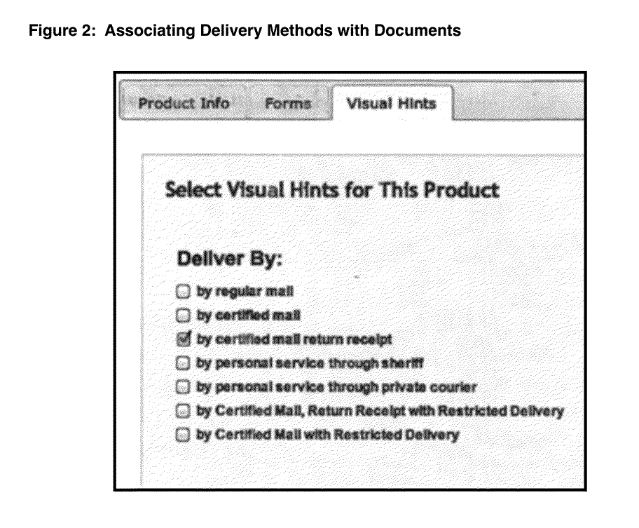

An example of how a system administrator may affiliate a document record with a delivery method record is shown in FIG. 2. Here, the administrator can select a delivery method (i.e. “by certified mail return receipt”) for the designated “Product.”

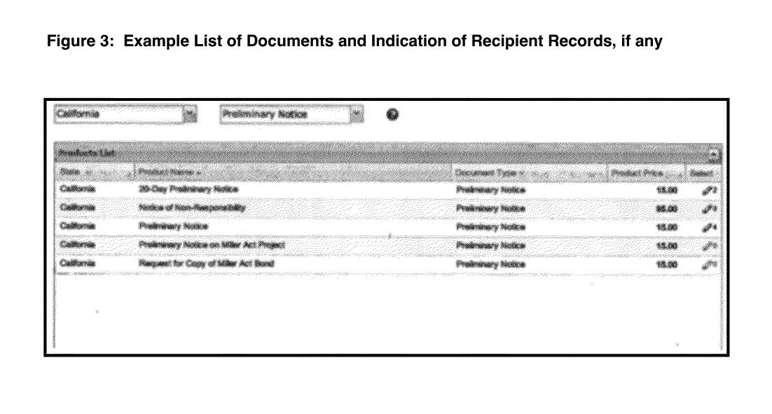

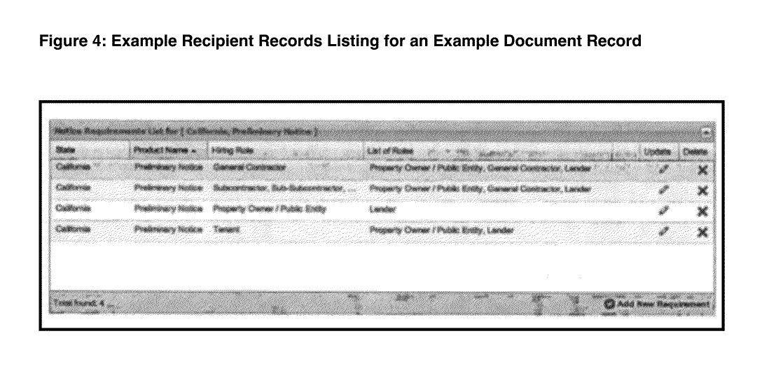

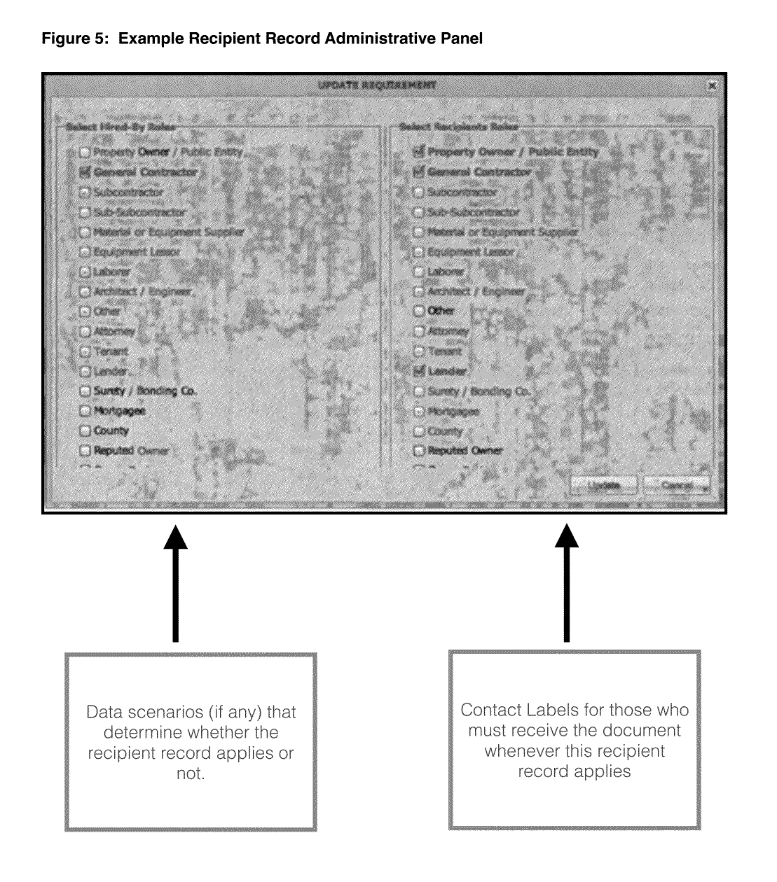

Examples of how system administrators may affiliate document record with “recipient records” is demonstrated by FIGS. 3, 4 and 5. FIG. 3 shows an example list of construction notice documents available for creation in the state of California. To the far right in each row in the chart, next to the pencil icon, there is an indication of the number of “recipient records” for each document. These individual “recipient records” are displayed in list format within FIG. 4. An individual recipient record is displayed in FIG. 5, which shows an administrative ability to associate “recipient roles”—recipient “contact labels”—for the recipient record.

The FIG. 5 example is separated into two columns. On the right hand side, the system associates certain contact labels, which indicates the recipients who are required to receive the document. This association is required in every scenario for this invention, as it is mandatory for required recipient contact labels to be identified and stored in the system. However, on the left hand side of the FIG. 5 interface, there is something not mandatory—this relates to the creation of a “data scenario.”

The left hand side of FIG. 5 associates the “hired by” contact labels, such that a rule is created the restricts a particular “recipient record” as applicable only when a certain data scenario exists. In this example, the data scenario is the “hired by” contact label. In the FIG. 5 example specifically, when the system user's customer is given the “General Contractor” contact label, then this recipient record would apply, making the document delivery required to the property owner/public entity, the general contractor, and the lender.

Third, the system contains system user generated data, or data specific to the system user. This is demonstrated within FIG. 10.3. Therein, the system user creates a project record (i.e. or an “item record’). The record will affiliate certain contact records, and the user can give those contact records labels. This creates an association within the computer program, system, database, or other data source between the contact record's identifiers and the contact label identifier. The system user may then seek to delivery a document, which may be done through an affirmative selection or a system process to select the same automatically, the consequence of which is that a document record identifier is affiliated with the system user's item record. And finally, contained within FIG. 10.3 is also a reference to a “hiring” party, which may or may not be required to perform the process of this invention, but is likely required with respect to the example of construction notices. This refers to the system user selecting from the contact records affiliated with his or her item record the contact that “hired” the system user, or the system user's actual customer.

All of this system user data is used, in connection with the general data within the system, to create the determination of what delivery method should be used and who should receive a particular document.

This invention's method and system of determining “delivery methods” and “recipients” is the process—conducted through a computer—consisting of the following steps and components:

(1) The system user manually through a user, device, or computer interface, or through an automation, selects a particular document for ordering, generating, requesting, downloading, mailing, sending, or otherwise acquiring, which is selected in connection with an “item record;”
(2) The subject document's record within the computer program, system, database, or other data source is examined for affiliated “delivery method” identifiers, and the affiliated methods are extracted;
(3) The subject document's record within the computer program, system, database, or other data source is examined for affiliated “recipient record” identifiers, which is a record of either: (i) which contact labels must receive the document; or (ii) which contact labels must receive the document depending on some data scenario, such as the “contact label” affiliated with the contact who is designed as the system user's customer, and the affiliated recipient records are extracted.
(4) The extracted and affiliated recipient records are, by the computer program or system, examined and compared with the system user's subject “item record,” to (i) identify which specific contact records match the recipient “contact labels,” or, (ii) if the recipient requirements depend on some data scenario, such as the label of an hiring contact, then to examine the scenario to match the item record's data scenario to the applicable recipient record, and when a match is located, to identify which specific contact records match the recipient “contact labels” that apply.

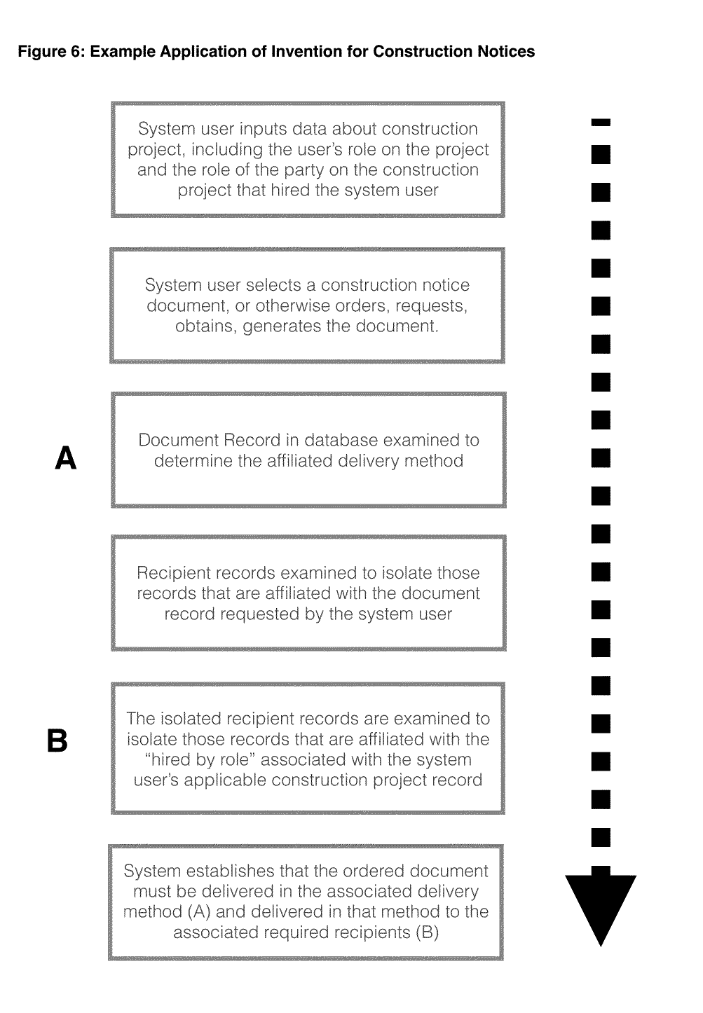

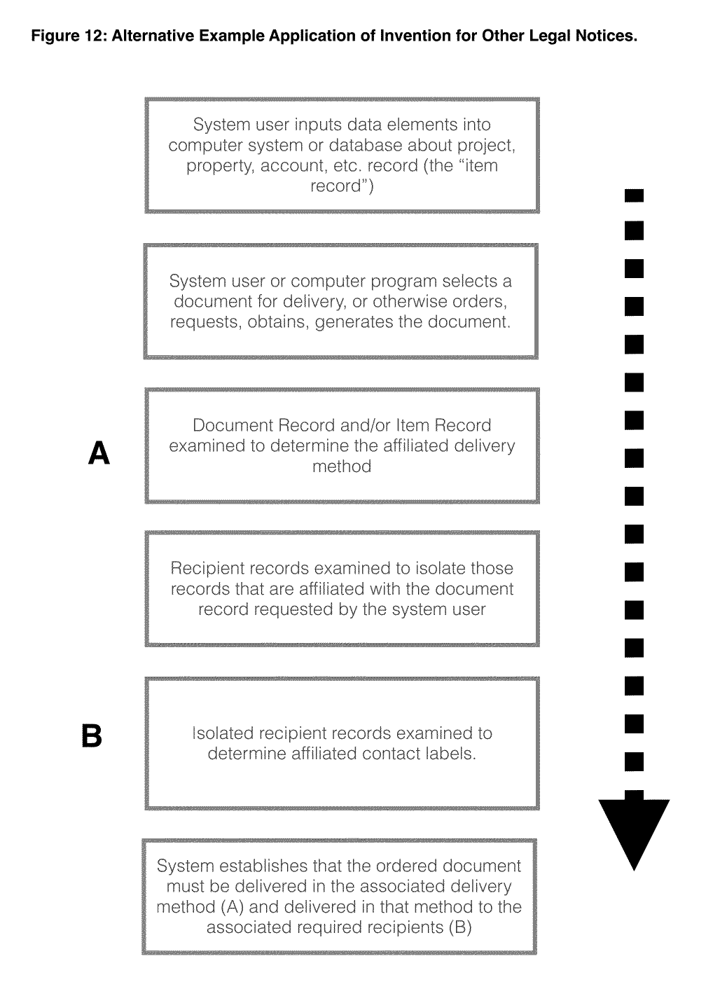

This process is demonstrated in the FIG. 6 and FIG. 12 charts.

The FIG. 6 chart uses the example of construction notices, whereby the “recipient record” does depend on a special data scenario, as referenced by steps (3)(ii) and (4)(ii), supra. Since special data scenarios apply, the part B of FIG. 6 requires examination of the recipient records and the item record to determine which recipient records apply based on the “hired by role”—the contact label associated with the contact record marked as the system user's customer, in this construction notice example.

The FIG. 12 chart, on the other hand, does not depend on any data scenarios, and therefore is referenced by steps (3)(i) and (4)(i), supra. Since no special data scenarios apply, the part B of FIG. 12 simply looks to the recipient records affiliated with the subject document and extracts the list of contact labels that are applicable. The contact labels applicable, in other words, will not depend on any “qualifying” data scenario (i.e. such as what contact label is designated as the customer by the system user in the item record).

### B: System and Method for Displaying or Suggesting Delivery Method and Delivery Recipients to System Users

This invention's method performs a process through a computer system to determine how certain documents—i.e. construction notices, other legal notices, or other documents—must be delivered, and to whom the documents must be delivered. The process of organizing and managing the rules that guide this process, and the method and system of calculating the requirements in relation to specific system user data, all by a computer, is explained above in Part A.

This Part B component of the invention examines the system and method of transforming the calculated requirements from Part A into displayed instructions or suggestions to a system user or administrator.

Important to this component of the invention is the labeling of “delivery methods” and “contacts” as above explained and demonstrated by the example database table structure within FIGS. 1.1, 1.2 and 1.3. As demonstrated, each “delivery method” record within the computer program, system, database, or data source is provided a “delivery method name” and “delivery method description.” 1.1. Further, the same labeling occurs for contact labels, which have a “contact label name.” 1.3.

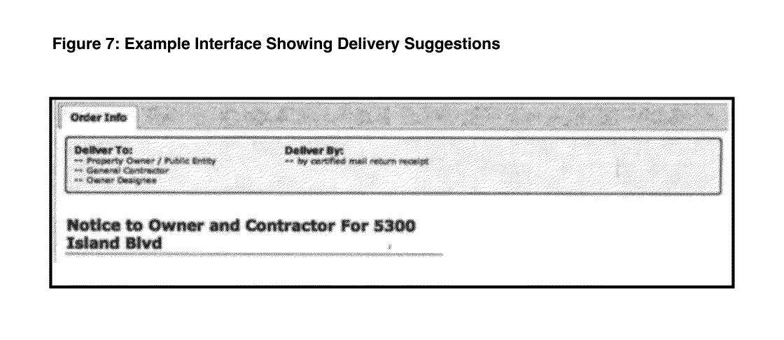

FIG. 7 provides an example user, computer, or device interface whereby the calculated delivery requirements are displayed to a system user or administrator. In this FIG. 7 example, a particular document record is related to an item record: “Notice to Owner and Contractor”—a construction notice, and specific document record—“For 5300 Island Blvd”—a project address, related to a user's specific project record or item record.

A box with the instructions is displayed to the user in the interface, by the computer, showing: (i) Deliver To data, which is a listing of all contact labels who are determined should receive the document, as per the process of Part A; and (ii) Delivery By data, which is an identification of the delivery method determined relative to the document pursuant to the process of Part A.

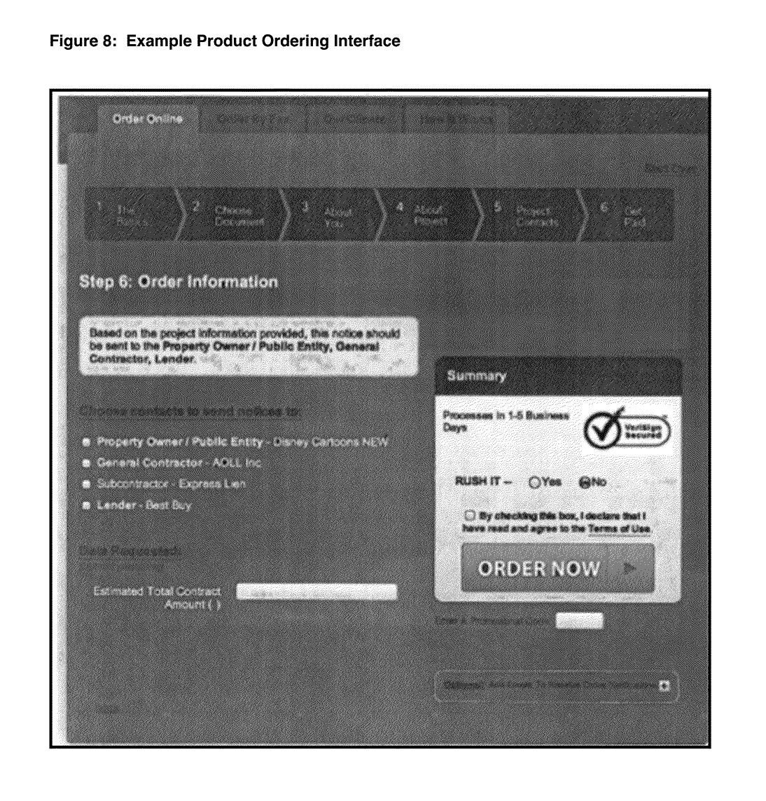

FIG. 8 provides another example of this calculated delivery requirement(s) being displayed to a system user or administrator. In this example, the requirements are displayed through a “Product Ordering Interface.” As you can see in the drawing, the required recipients are suggested by the following language: “Based on the project information provided, this notice should be sent to the Property Owner/Public Entity, General Contractor, Lender.” The user is then shown a listing of all contacts associated with the relevant project record or item record, and the user can select which of the contacts they would like to receive the specific document. In this FIG. 8 example, it can be noted, there is no indication of the delivery method.

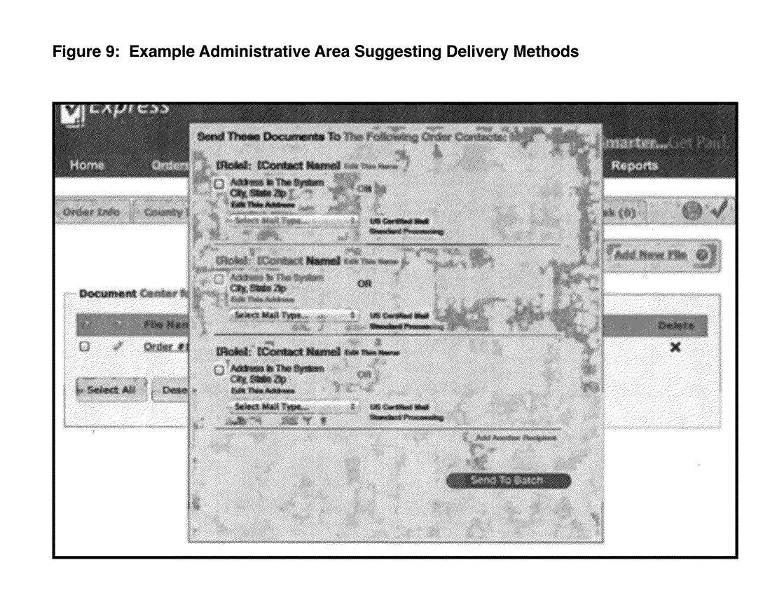

FIG. 9 provides another example of this calculated delivery requirement(s) being displayed to the system user or administrator. In this example, a user, device, or computer interface is providing the user or administrator the ability to select which contacts will receive the document, and the interface is providing the user with the function of “Send to Batch,” which will take the documents and send them to a batch for mailing, delivery, or handling. Here, again, the contacts that are required will be indicated by automatic selection or in some other manner, and the required delivery method will be indicated by automatic selection or some other manner.

This invention does not claim the underlying process and/or method of handling, mailing, or delivering a document. It is further not a claim on the process, method, or system of simply displaying usability instructions to a user through a user interface.

Instead, this invention claims and relates to the connecting and associating of “delivery methods” and “required recipients” to a specific document that is subject to mailing, and by comparing those associated requirements to the system user's data about a specific project, property, account, or item, determining how a particular document must be sent and who it must be sent to, and thereafter, as per this Part B, displaying those instructions or suggestions to the user through a computer, device, or user interface.

### C. System and Method for Dictating Delivery Method and Delivery Recipients Based on System User Data Through an Automated Process

This invention's method performs a process through a computer system to determine how certain documents—i.e. construction notices, other legal notices, or other documents—must be delivered, and to whom the documents must be delivered. The process of organizing and managing the rules that guide this process, and the method and system of calculating the requirements in relation to specific system user data, all by a computer, is explained above in Part A. A system and method of displaying and/or suggesting the “delivery method” and “required recipients” deemed mandatory is explained in the above Part B.

This Part C component of the invention examines the system and method of dictating, through the output of the process and method of Part A, how certain documents must be sent and to whom, and creating an output from the system of this data, through some automated process, such that the subject items will be handled, delivered, and/or mailed pursuant to the determined requirements.

This invention does not claim the underlying process and/or method of handling, mailing, or delivering a document, either electronically, automatically, or manually. It is further not a claim on the general principal of creating batch records that are transmitted to third parties, or of creating batch records of documents and instructions that are used to print, sort, delivery, mail, and/or transmit certain data or documentation.

Instead, this invention claims a system or method of putting items into some batch file based on the process established by Part A, supra. The batch file will consist of a reference to: (i) The document that must be delivered; (ii) The recipients who must receive those documents; and (iii) The delivery method for those recipients.

Individual items may be entered into the batch, with the requirements calculated and determined by Part A, either manually through a system user or system administrators command, given to the computer through a system interface, to place the items in the batch in accordance with the suggestion (or in defiance of the same) displayed to the user as explained in Part B, supra. This invention also contemplates items being placed in a batch in accordance with the requirements calculated and determined by Part A without any manual input from the system user or system administrators, but instead, according to an automated process to handle documents pursuant to the Part A calculations, or some systemized augmentation thereof.

What is claimed is:

1. A computer implemented method and system of establishing, organizing, and storing system rules, within a database or script, operatively connected to a computer or computer system, about how certain documents or items must be delivered, and to whom, through the method comprising the steps of:
a. Storing, in a computer database, data source, or program, individual records for each document or item that will be subject to a delivery, and providing each record with an identifier;
b. Storing, in a computer database, data source, or program, individual records to identify each potential “delivery method,” and providing each delivery method record with an identifier;
c. Storing, in a computer database, data source, or program, individual records to identify each potential “contact label,” and providing each contact label record with an identifier;
d. Associating, in a computer database, data source, or program, individual document record identifiers (stored as per subpart (a) above) with delivery method identifiers (stored as per subpart (b) above), with said association occurring by referencing and connecting the applicable identifiers within the computer database, data source, or program;
e. Associating, in a computer database, data source, or program, individual document record identifiers (stored as per subpart (a) above) with contact label identifiers (stored as per subpart (c) above), with said association occurring by referencing and connecting the applicable identifiers within the computer database, data source, or program;
f. The result of said storing and associating, through subparts (a) through (e), all within a computer database, data source, or program, is the creation of a rule, read and implemented by a computer or computer program, whereby specific document records must be delivered according to the associated delivery methods associated in subpart (d), to the recipient contact labels associated in subpart (e).

2. The method of claim 1 wherein subparts (e) and (f) are replaced with the following:
e. Associating, in a computer database, data source, or program, individual document record identifiers (stored as per subpart (a) above) with a data scenario qualifier, which dictates that a certain data element must exist for the record to apply, and thereafter, if the data element does exist, a contact label identifier (stored as part (c) above, with said association occurring by referencing and connecting the applicable identifiers within the computer database, data source, or program;
f. The result of said storing and associating, through subparts (a) through (e), all within a computer database, data source, or program, is the creation of a rule, read and implemented by a computer or computer program, whereby specific document records must be delivered according to the associated delivery methods associated in subpart (d), to the recipient contact labels associated in subpart (e) that are relevant based on the existence of a specific data element(s) mandated by the data scenario qualifier.

3. A computer implemented method and system of determining how certain documents must be delivered, and to whom, through the method comprising the steps of:
a. Retrieving, by the computer or computer program, from the database, the identifier associated with the document, selected by the user for delivery.
b. Examining, by the computer or computer program, within the database, data source, script, or program, the retrieved document record from subpart (a), to locate affiliated delivery methods and extracting the associated delivery method identifier(s);
c. Examining, by the computer or computer program, within the database, data source, script, or program, the retrieved document record from subpart (a), to locate affiliated contact labels and extracting the associated contact label identifier(s);
d. The result of said retrievals and examinations, through subparts (a) through (c), all within a computer database, data source, or program, is the determination, by the computer or computer program, that for a certain identified document record, it must be delivered pursuant to the delivery method identified in subpart (b) to the recipients with the affiliated contact label(s) identified by subpart (c).

4. The method of claim 3 wherein the subject document, “selected by the user for delivery” pursuant to subpart (a), is instead selected or identified, automatically, systematically, or otherwise, by the computer program, computer script, database, data source, or computer.

5. The method of claim 3 whereby the document in question is selected or identified, in addition to for “delivery,” for ordering, requesting, obtaining, generating, attaining, naming, preparing for delivery, or otherwise labeling.

6. The method of claim 3 whereby subpart (c) and subpart (d) are replaced with the following:
c. Examining, by the computer or computer program, within the database, data source, script, or program, the retrieved document record from subpart (a), to:
i. Locate affiliated data scenario qualifiers, which dictates that a certain data element must exist for the record to apply, and extracting the associated data element identifiers that must exist; and
ii. Locate the contact labels affiliated with the data scenario qualifier records, and extracting the associated contact label identifiers.
a. The result of said retrievals and examinations, through subparts (a) through (c), all within a computer database, data source, or program, is the determination, by the computer or computer program, that for a certain identified document record, it must be delivered pursuant to the delivery method identified in subpart (b) to the recipients with the affiliated contact label(s) identified by subpart (c), if the data scenario qualifier (i.e. qualifying data element) is present within the system user's data set relevant to and associated with the subject document.

7. A computer implemented method and system of determining how certain documents must be delivered, and to whom, in relation to specific system user data, present within a database or script, operatively connected to a computer or computer system, through the method comprising the steps of:
a. Retrieving, by the computer or computer program, from the database, the identifier associated with the document, selected by the user for delivery.
b. Examining, by the computer or computer program, within the database, data source, script, or program, the retrieved document record from subpart (a), to locate affiliated delivery methods and extracting the associated delivery method identifier(s);
c. Examining, by the computer or computer program, within the database, data source, script, or program, the retrieved document record from subpart (a), to locate affiliated contact labels and extracting the associated contact label identifier(s);
d. Examining, by the computer or computer program, within the database, data source, script, or program, the system user's item record (i.e. project record, account record, property record, etc.), relevant to and associated with the subject document selection, to locate any contact records affiliated with the item record that are associated with the contact label identifiers extracted and located through subpart (c).
e. The result of said retrievals and examinations, through subparts (a) through (d), all within a computer database, data source, or program, is the determination, by the computer or computer program, that for a certain identified document record, it must be delivered pursuant to the delivery method identified in subpart (b) to the recipients identified by subpart (d).

8. The method of claim 7 wherein the subject document, “selected by the user for delivery” pursuant to subpart (a), is instead selected or identified, automatically, systematically, or otherwise, by the computer program, computer script, database, data source, or computer.

9. The method of claim 7 whereby the document in question is selected or identified, in addition to for “delivery,” for ordering, requesting, obtaining, generating, attaining, naming, preparing for delivery, or otherwise labeling.

10. The method of claim 7 whereby subparts (c), (d), and (e) are replaced with the following:
c. Examining, by the computer or computer program, within the database, data source, script, or program, the retrieved document record from subpart (a), to:
i. Locate affiliated data scenario qualifiers, which dictates that a certain data element must exist for the record to apply, and extracting the associated data element identifiers that must exist; and
ii. Locate the contact labels affiliated with the data scenario qualifier records, and extracting the associated contact label identifiers;
a. Examining, by the computer or computer program, within the database, data source, script, or program, the system user's item record (i.e. project record, account record, property record, etc.), relevant to and associated with the subject document selection, to (i) locate the existence of any data element identifiers which were extracted from the process in subpart (c)(i); and (ii) If the data scenario qualifier's data element exists within the same, to locate any contact records affiliated with the user's subject item record that are associated with the contact label identifiers extracted and located through subpart (c)(ii), which are associated with the data scenarios determined to apply to the user's subject item record as per this subpart (d);
b. The result of said retrievals and examinations, through subparts (a) through (d), all within a computer database, data source, or program, is the determination, by the computer or computer program, that for a certain identified document record, it must be delivered pursuant to the delivery method identified in subpart (b) to the recipients identified by subpart (d).

11. A computer implemented method and system of displaying or suggesting, by a computer or computer program through a computer, device, or user interface, how certain documents must be delivered, and to whom, through the method comprising the steps of:
a. Determining, by the computer or computer program, through the method and system described in claims 3 through 10, how a certain document must be delivered, and to whom;
b. Examining, by the computer or compute program, the determined “delivery method” and “contact labels” and extracting, from the database, data source, computer program, or system, the identifiers for each;
c. Examining, by the computer or computer program, the database, data source, computer program, or system, to locate the textual name(s) and/or description(s) associated with the extracted identifiers;
d. Within a system interface, computer interface, device interface, or Product Ordering Interface, displaying the extracted delivery methods' name and/or description to the system user to indicate, suggest, instruct, or select the delivery method for the subject document;
e. Within a system interface, computer interface, device interface, or Product Ordering Interface, displaying the extracted contact labels' name and/or description to the system user to indicate, suggest, instruct, or select the contacts as recipients for the subject document;

12. The method of claim 11 when subpart (d) is used without subpart (e), or vice versa.

13. The method of claim 11 wherein the computer system or program does not retrieve from the database, data source, program, or system (the “database”), or the database does not store any textual or specific identifying information about the delivery method record and/or the contact label record, and therefore, does not display such identifying information, instead simply enabling the system user, without the textual identifications or markers, to initiate a delivery, request, order, download, acquisition, or some other generation of the document pursuant to the requirements calculated as described in claims 3 through 10.

14. A computer implemented method and system of dictating how certain documents must be sent and to whom, and creating, through a computer or computer program, an output from the system of this data, through the method consisting of the following steps:
a. Determining, by the computer or computer program, through the method and system described in claims 3 through 10, how a certain document must be delivered, and to whom;
b. Generating, by the computer or computer program, an output file in a readable format (such as xml, csv, or xls) that contains:
i) A reference to the subject document, enabling the document's download, generation, assembly, or otherwise acquisition;
ii) Identification of the delivery method for the subject document; and
iii) Identification of each recipient, which may include the recipient's name and address, of the subject document.

15. The method of claim 14 whereby the output file is not in a particular format, but is instead transmitted or able to be transmitted through an application programming interface (API).

16. The method of claim 14 whereby the output file is not in a particular format, but is instead transmitted or able to be transmitted through electronic mail.

17. The method of claim 14 whereby the output file is not in a particular format, but is instead transmitted or able to be transmitted through any manner of communicating data.
